(19) United States
(12) Patent Application Publication
(10) Pub. No.: US 2013/0198266 A1
(43) Pub. Date: Aug. 1, 2013

(54) FACILITATING COMMUNICATION BETWEEN WEB-ENABLED DEVICES

(71) Applicant: 5o9, Inc., Boulder, CO (US)

(72) Inventors: Kevin J. Kiley, Bigelow, AR (US); Peter J. Cranstone, Parker, CO (US)

(73) Assignee: 5O9, INC., Boulder, CO (US)

(21) Appl. No.: 13/753,749

(22) Filed: Jan. 30, 2013

Related U.S. Application Data
(60) Provisional application No. 61/592,475, filed on Jan. 30, 2012.

(51) Int. Cl. H04L 29/08

(52) U.S. Cl. CPC H04L 67/02
USPC 709/203

(57) ABSTRACT

Methods and systems for facilitating communication between Web-enabled devices are provided. According to one embodiment, remote initiation and running of native JavaScript commands inside a browser is facilitated. A script, including one or more native JavaScript commands, is executed by a first device. The native JavaScript commands are caused to be carried out within a Web browser running on a target Web-enabled device by transmitting the native JavaScript commands to the target Web-enabled device via a Hypertext Transfer Protocol (HTTP) tunnel through a network to which both the first device and the target Web-enabled device are coupled. The native JavaScript commands are targeted for the Web browser by virtue of a unique identifier of the target Web-enabled device and without requiring knowledge, by the first device, of an Internet Protocol (IP) address of the target Web-enabled device.

### CROSS-REFERENCE TO RELATED APPLICATIONS

This application claims the benefit of U.S. Provisional Application No. 61/592,475, filed on Jan. 30, 2012, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2012-2013 5o9, Inc.

### BACKGROUND

1. Field

Embodiments of the present invention generally relate to Internet communications and Web-enabled devices. More specifically, embodiments of the present invention provide a method that facilitates communication between Web-enabled devices without the source device needing to know either the domain name or Internet Protocol (IP) address of the remote (target) device.

2. Description of the Related Art

We now live in a world where virtually every electronic device either connects to the Internet or will connect to it in the future. We've gone from a personal computer (PC) focused era to one where even a washing machine can be connected to the Web via a TCP/IP connection and/or an HTTP enabled browser. Perhaps the largest change we've experienced is in the context of mobile telecommunications, where a cellular radio signal or the like now transmits Web data.

Up until this point, the mobile industry has architected their wireless networks and devices for simple client (consumer) applications only. Mobile app developers generally have been restricted by firewalls, dynamic IP address and other wireless architecture impediments from developing generic reachable Internet services on mobile devices.

### SUMMARY

Methods and systems are described for facilitating communication between Web-enabled devices. According to one embodiment, a method is provided that allows remote initiation and running of native JavaScript commands inside a browser within the JavaScript sandbox in a networking environment in which the IP address of the remote (target) device is not accessible. A script, including one or more native JavaScript commands, is executed by a first device. The native JavaScript commands are caused to be carried out within a Web browser running on a target Web-enabled device by transmitting the native JavaScript commands to the target Web-enabled device via a Hypertext Transfer Protocol (HTTP) tunnel through a network to which both the first device and the target Web-enabled device are coupled. The native JavaScript commands are targeted for the Web browser by virtue of a unique identifier of the target Web-enabled device and without requiring knowledge, by the first device, of an Internet Protocol (IP) address of the target Web-enabled device.

According to another embodiment, a method is provided that allows remote initiation and running of native browser commands ‘outside’ the JavaScript sandbox within an environment in which the IP address of the remote (target) device is not accessible. A program or script, including one or more calls to an application programming interface (API) of a Web browser running on a target Web-enabled device, is executed by a first device. The native Web browser commands are caused to be carried out by the Web browser by transmitting the API calls to the target Web-enabled device via an HTTP tunnel through a network to which both the first device and the target Web-enabled device are coupled. The API calls are targeted for the Web browser by virtue of a unique identifier of the target Web-enabled device and without requiring knowledge, by the first device, of an IP address of the target Web-enabled device.

According to yet another embodiment, a method is provided that allows remote initiation and running of any native application or operating system application programming interface in a networking environment in which the IP address of the remote (target) device is not accessible. A program or a script, including one or more calls to an API of an application or an operating system running on a target Web-enabled device, is executed by a first device. One or more operations are caused to be carried out by the application or the operating system by transmitting the one or more API calls to the target Web-enabled device via an HTTP tunnel through a network to which both the first device and the target Web-enabled device are coupled. The one or more API calls are targeted for the application or the operating system by virtue of a unique identifier of the target Web-enabled device and without requiring knowledge, by the first device, of an IP address of the target Web-enabled device.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram conceptually illustrating a simplified network environment in which embodiments of the present invention may be employed.

FIG. 2 is a block diagram conceptually illustrating various functional units of a source Web-enabled device, a Web device name server and a target Web-enabled device in accordance with one embodiment of the present invention.

FIG. 3 is an example of a computer system with which embodiments of the present invention may be utilized.

FIG. 4 is a flow diagram illustrating source Web-enabled device processing in accordance with an embodiment of the present invention.

FIG. 5A is a flow diagram illustrating Web device name server request processing in accordance with an embodiment of the present invention.

FIG. 5B is a flow diagram illustrating Web device name server polling processing in accordance with an embodiment of the present invention.

FIG. 6 is a flow diagram illustrating target Web-enabled device processing in accordance with an embodiment of the present invention.

FIG. 7 is a block diagram illustrating processing performed by a source Web-enabled device and interactions between the source Web-enabled device and a Web device name server in accordance with a simplified demonstration of an embodiment of the present invention.

FIG. 8 is a block diagram illustrating processing performed by a Web device name server and interactions between the Web device name server and a source Web-enabled device and a target Web-enabled device in accordance with a simplified demonstration of an embodiment of the present invention.

FIG. 9 is a block diagram illustrating processing performed by a target Web-enabled device and interactions between the target Web-enabled device and a Web device name server in accordance with a simplified demonstration of an embodiment of the present invention.

### DETAILED DESCRIPTION

Systems and methods are described for facilitating communication between Web-enabled devices without the need for the source device to know either the domain name or IP address of the remote (target) device. According to one embodiment, uniform “direct connect” applications are enabled by a protocol, Web Device Name Protocol (WDNP), which may, but need not be used as a “left of colon” protocol (i.e., wdnp://<devicename>). In one embodiment, WDNP is a generic method that facilitates communication between Web-enabled devices, without the need to know either the domain name or IP address of the remote device. It expands app developer horizons to enable uniform “direct connect” applications, on not only mobile platforms (e.g., Symbian, BB, WM, iOS, Android . . . ) but any other connected to device, to run reachable Internet services.

One of many goals of various embodiments of the present invention is to extend the power of scripting to networking environments in which the Internet Protocol (IP) address of a target Web-enabled device is not available/accessible to a source Web-enabled device from which one would like to control, monitor or otherwise interact with the target. One strength of scripting is the ability to leverage existing command-line and/or application programming interface (API) driven applications or operating systems to automate mundane, repetitive tasks, for example. Using the various source-to-target communication models described herein, developers are provided with the ability to, among other things, remotely initiate and run, from a source Web-enabled device or a server:
native JavaScript commands inside a browser within the JavaScript sandbox in a networking environment in which the IP address of the remote (target) device is not accessible;
native browser commands ‘outside’ the JavaScript sandbox within an environment in which the IP address of the remote (target) device is not accessible; and/or
any native application or operating system application programming interface within an environment in which the IP address of the remote (target) device is not accessible.

In one embodiment, a peer-to-peer connection is established between a source Web-enabled device and a target Web-enabled device via a Web device name server. For example, native instructions, commands and/or requests of a Web browser, an automated browser testing tool or a scripting application may be transported via a public network, such as the Internet, from a source Web-enabled device to a target Web-enabled device via a tunneling protocol to remotely control, monitor or otherwise interact with the target Web-enabled device. In various examples described herein, Hypertext Transport Protocol (HTTP) is the tunneling protocol and the instruction set is carried within standard headers or X-headers of an HTTP connection request.

For purposes of simplicity, various embodiments of the present invention are described in the context of running a scripting app residing on a source Web-enabled device on a remote (target) Web-enabled device and/or issuing commands and receiving responses from an automated browser testing tool over one or more public and private networks (e.g., the Internet and a carrier network) via Hypertext Transport Protocol (HTTP). It is to be noted, however, that the communication framework described herein is not so limited and is generally applicable to any scripting language (e.g., JavaScript, Selenium, Perl, Python, Ruby, etc.) or compiled language (e.g., Ada, C, C++, C#, Fortran, Java, Pascal, Visual Basic, etc.). Similarly, while various examples described herein use IPv4 conventions (e.g., assume a 32-bit address scheme), embodiments of the present invention are applicable to IPv4 and next generation Internet standards, such as IPv6 (a/k/a IPng), which, among other things, move to a 128-bit address space. Finally, those skilled in the art will recognize alternative protocol stacks can be used. For example, any network that allows for an HTTP connection can support the HTTP tunneling approach described herein.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

### Terminology

Brief definitions of terms used throughout this application are given below.

The terms “connected” or “coupled” and related terms are used in an operational sense and are not necessarily limited to a direct connection or coupling.

The term “client” generally refers to an application, program, process or device in a client/server relationship that requests information or services from another program, process or device (a server) on a network. Importantly, the terms “client” and “server” are relative since an application may be a client to one application but a server to another. The term “client” also encompasses software that makes the connection between a requesting application, program, process or device to a server possible, such as an email client.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The phrase “peer-to-peer” generally refers to a situation, model or environment in which each participating computer (node) can act as a client and/or a server for the others. In this manner, shared access is enabled among various resources, such as files, peripherals and sensors without the need for a centralized server-based service model. In embodiments of the present invention, a peer-to-peer HTTP tunnel is established between a source Web-enabled device and a target Web-enabled device through a Web device name server that allows the source to remotely control, monitor or otherwise interact with the target or a component thereof (e.g., a Web browser, Web application, service, operating system, etc.) without requiring the source to know the IP address of the target. In some embodiments, the peer-to-peer HTTP tunnel may be implemented as two separate HTTP tunnels—one between the source Web-enabled device and the Web device name server and another between the Web device name server and the target Web-enabled device.

The term “responsive” includes completely or partially responsive.

The term “server” generally refers to an application, program, process or device in a client/server relationship that responds to requests for information or services by another program, process or device (a server) on a network. The term “server” also encompasses software that makes the act of serving information or providing services possible. The term “server” also encompasses software that makes the act of serving information or providing services possible.

The phrase “unique device identifier” generally refers to one or more identifiers of a device, which used alone or in combination uniquely identify a Web-enabled device. Examples of unique device identifiers include, but are not limited to, an International Mobile Equipment Identity (IMEI) number of a GSM device, a Mobile Equipment Identifier (MEID), a Cellular Data Number (CDN), an Integrated Circuit Card ID (ICCID) number, a hardware ID (e.g., a processor ID, a CPU ID or a hard-drive serial number), a hardware or physical address (e.g., a Media Access Control (MAC) address), an ID of a sensor or peripheral (essentially anything connected via a COM port) of a Web-enabled device and the like. In embodiments of the present invention, an intermediate server logically interposed between a source Web-enabled device and a target Web-enabled device defines a peer-to-peer connection between the source and target based on a unique identifier that identifies the target device uniquely. The unique identifier could also be represented by a unique key that is randomly generated by the device, which is synched to a server side key using the same random generation sequence. Like the RSA key chain, it could also be a combination of the carrier and geo-location.

The phrase “Web-enabled device” generally refers to any device that is capable of accessing the Internet. Non-limiting examples of Web-enabled devices include smartphones, pocket Personal Computers (PCs), ultra mobile PCs (UMPCs), tablet computers, BlackBerry® wireless handheld devices, iPhones, Android devices, desktop/laptop computers, web servers, set top boxes, smart televisions (TVs), Web-enabled TVs, printers, routers, switches and the like—basically any device that enables a network (e.g., TCP/IP) connection (wired or wireless), which can carry the tunneling protocol (e.g., HTTP) used for the particular implementation.

Overview

Devices that support the generic communication (WDNP) approach in accordance with embodiments of the present invention can now have:
Direct Connect—instant-on, ad hoc, anywhere & peer-2-peer device Internet services
Direct Content Push—this now becomes truly platform agnostic avoiding proprietary schemes
Features like security/privacy/authorization, ad hoc (instant on) anywhere services, location, mobile firewall traversal, bandwidth brokering can now be uniformly implemented once, and the code and infrastructure shared/reused across all relevant Web enabled device platforms

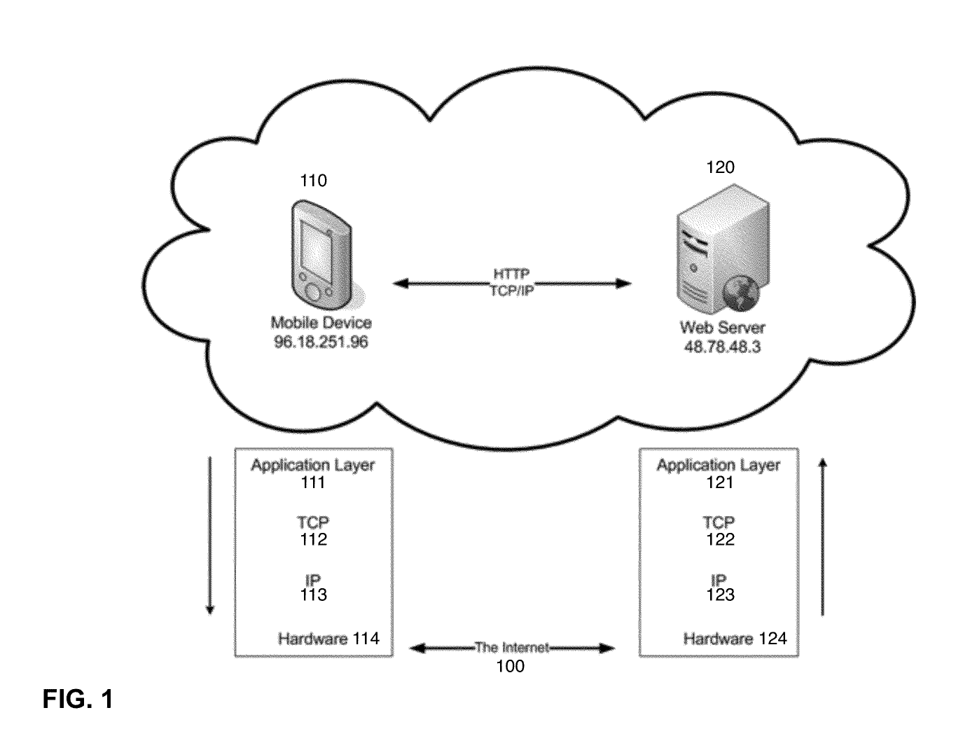

FIG. 1 is a block diagram conceptually illustrating a simplified network environment in which embodiments of the present invention may be employed. In the present example, a mobile device 110 is shown transmitting an HTTP packet to a web server 120 over TCP/IP via the Internet 100.

The Internet is a global network of computers. Each computer connected to the Internet must have a unique address. Internet addresses are in the form xxx.xxx.xxx.xxx where xxx must be a number from 0-255. This address is known as an Internet Protocol (IP) address. When a Web-enabled device, such as mobile device 110, connects to the Internet through an Internet Service Provider (ISP), it is usually assigned a temporary IP address for the duration of the session. As noted above, while the present example is described in the context of IPv4's 32-bit address space, embodiments of the present invention are not so limited and are applicable to next generation Internet standards, such as IPv6 (a/k/a IPng), which, among other things, move to a 128-bit address space.

If the connection to the Internet is from a local area network (LAN), the Web-enabled device (e.g., a mobile device or desktop computer) might have a permanent IP address or it might obtain a temporary one from a Dynamic Host Configuration Protocol (DHCP) server. Whenever one is connected to the Internet, there is always a unique IP address associated with the Web-enabled device at issue. In the context of mobile devices, it is the service provider's responsibility to use their routers to maintain the appropriate connection for requests (e.g., HTTP requests) coming from the mobile device (e.g., a Web browser running on the mobile device) and the IP address for the mobile device may not be made available outside of the service provider network.

To communicate with other Web-enabled devices that are connected to the Internet, a protocol stack is used. The protocol stack used on the Internet is referred to as the TCP/IP protocol stack because of the two major communication protocols used—TCP, which stands for Transmission Control Protocol, and IP, which stands for Internet Protocol.

In the present example, a protocol stack is show for both mobile device 110 and web server 120. The protocol stack includes an application layer 111 and 121, a TCP layer 112 and 122, an IP layer 113 and 123 and a hardware layer 114 and 124. The application layer 111 and 121 represents protocols specific to applications, such as WWW (browser), email, FTP etc. These protocols facilitate specific data communication services on a process-to-process level. The TCP layer 112 and 122 handles host-to-host communication by, for example, directing packets to a specific application on a computer using a port number using a socket. The IP layer 113 and 123 connects local networks, for example, by routing packets to a specific computer using an IP address using a socket. The hardware layer 114 and 124 contains communication technologies for a local network, for example, by converting binary packet data to network signals and back (e.g., Ethernet network card, modem) for telecommunications.

TCP/IP Socket Description

A network socket is an endpoint of an inter-process communication flow across a computer network. Today, most communication between computers is based on the Internet Protocol; therefore, most network sockets are Internet sockets. A socket API is an application programming interface (API), usually provided by the operating system, that allows application programs to control and use network sockets. Internet socket APIs are usually based on the Berkeley sockets standard. A socket address is the combination of an IP address and a port number, much like one end of a telephone connection is the combination of a phone number and a particular extension. Based on a socket address, Internet sockets deliver incoming data packets to an appropriate application process or thread associated with the socket address.

To connect to another computer on the Internet, the IP address of that computer must be known. For example, in the context of FIG. 1, the conventional approach for mobile device 110 to send a message to Web server 120 would be to use its IP address (i.e., 48.78.48.3). But what if the IP address of the target computer is not available to the device attempting to make the connection? For example, what if one wanted to access a Web server specified by a domain name of www.3PMobile.com? How does the Web browser know where on the Internet this Web server is? The answer is the Domain Name Service or DNS. DNS is a distributed database that keeps track of computers' names and their corresponding IP addresses on the Internet.

Many computers connected to the Internet host part of the DNS database and the software that allows others to access it. These computers are known as DNS servers. No DNS server contains the entire database; they only contain a subset of it. If a DNS server does not contain the domain name requested by another computer, the DNS server re-directs the requesting computer to another DNS server. The Domain Name Service is structured as a hierarchy similar to the IP routing hierarchy. The computer requesting a name resolution will be re-directed ‘up’ the hierarchy until a DNS server is found that can resolve the domain name in the request.

When an Internet connection is setup, one primary and one or more secondary DNS servers are usually specified as part of the installation. This way, any Internet applications that need domain name resolution will be able to function correctly. For example, when a Web address is entered into a Web browser, the browser first connects to the primary DNS server. After obtaining the IP address for the domain name entered, the browser then connects to the target computer and requests the desired Web page within the specified domain.

Applications Protocols: HTTP

One of the most commonly used services on the Internet is the World Wide Web (WWW). The application protocol that makes the Web work is Hypertext Transfer Protocol or HTTP. HTTP is the protocol that Web browsers and Web servers use to communicate with each other over the Internet. It is an application level protocol because it sits on top of the TCP layer in the protocol stack and is used by specific applications to talk to one another. In this case, the applications are Web browsers and Web servers. HTTP 1.0 is a connectionless text-based protocol. Clients (e.g., Web browsers) send requests to Web servers for Web elements, such as Web pages and images. After the request is serviced by a server, the connection between client and server across the Internet is disconnected. As such, a new connection must be made for each request.

Most other communications protocols are connection oriented. This means that the two computers communicating with each other keep the connection open over the Internet. HTTP 1.0 does not however. Before an HTTP 1.0 request can be made by a client, a new connection must be made to the server. HTTP 1.1 makes persistent connections the default. HTTP/1.1 clients, servers, and proxies assume that a connection will be kept open after the transmission of a request and its response. The protocol does allow an implementation to close a connection at any time, in order to manage its resources, although it is best to do so only after the end of a response.

Because an implementation may prefer not to use persistent connections if it cannot efficiently scale to large numbers of connections or may want to cleanly terminate one for resource-management reasons, HTTP 1.1 permits use of a Connection: close header to inform the recipient that the connection will not be reused.

Another limitation of the HTTP protocol is that it is stateless. As described further below, one advantage of embodiments of the present invention is that device state can be added to requests.

When one types a Uniform Resource Locator (URL) into a Web browser, this is what happens:
1. If the URL contains a domain name, the browser first connects to a domain name server and retrieves the corresponding IP address for the Web server.
2. The Web browser connects to the Web server and sends an HTTP request (via the protocol stack) for the desired Web page.
3. The Web server receives the request and checks for the desired page. If the page exists, the Web server returns it. If the server cannot find the requested page, it will send an HTTP 404 error message. (404 means ‘Page Not Found’ as anyone who has surfed the Web probably knows.)
4. The Web browser receives the requested page and the connection is closed.
5. The browser then parses through the page and looks for other page elements it needs to complete the Web page. These usually include images, applets, etc.
6. For each element needed, the browser makes additional connections and HTTP requests to the server for each element.
7. When the browser has finished loading all images, applets, etc. the page will be completely loaded in the browser window.

Web Device Name Protocol

As mentioned above, developers generally have been restricted by firewalls, dynamic IP address and other wireless architecture impediments from developing generic reachable Internet services on Web-enabled devices. Consider a scenario in which one Web-enabled device (the source Web-enabled device) would like to send an HTTP packet to a mobile Web-enabled device (the target Web-enabled device) whose IP address is unknown. The IP address of the target Web-enabled device may be unavailable to the source Web-enabled device due to restrictions imposed by the target device's service provider or it may be effectively unavailable as a result of the frequent changes over time as a result of the target device's movement between tower coverage areas, for example. Similarly, the target device may move between carrier networks. For example, a mobile device typically used in the US is roaming when operating in Europe.

Conventional HTTP communication cannot take place when the originating device does not know either the IP address or the domain name of the target device or is prevented from knowing that by the security restrictions or operating policies of the service provider who maintains the network connection for the target device. However, using embodiments of the present invention, a source Web-enabled device can communicate with a target Web-enabled device via HTTP without the source device needing to know either the domain name or IP address of the target device. The following description describes how generic, standard, off the shelf programming techniques, can now communicate with any Web-enabled device either using TCP sockets, HTTP, or even email, and then deliver Internet services, without the need to know the remote device's IP address.

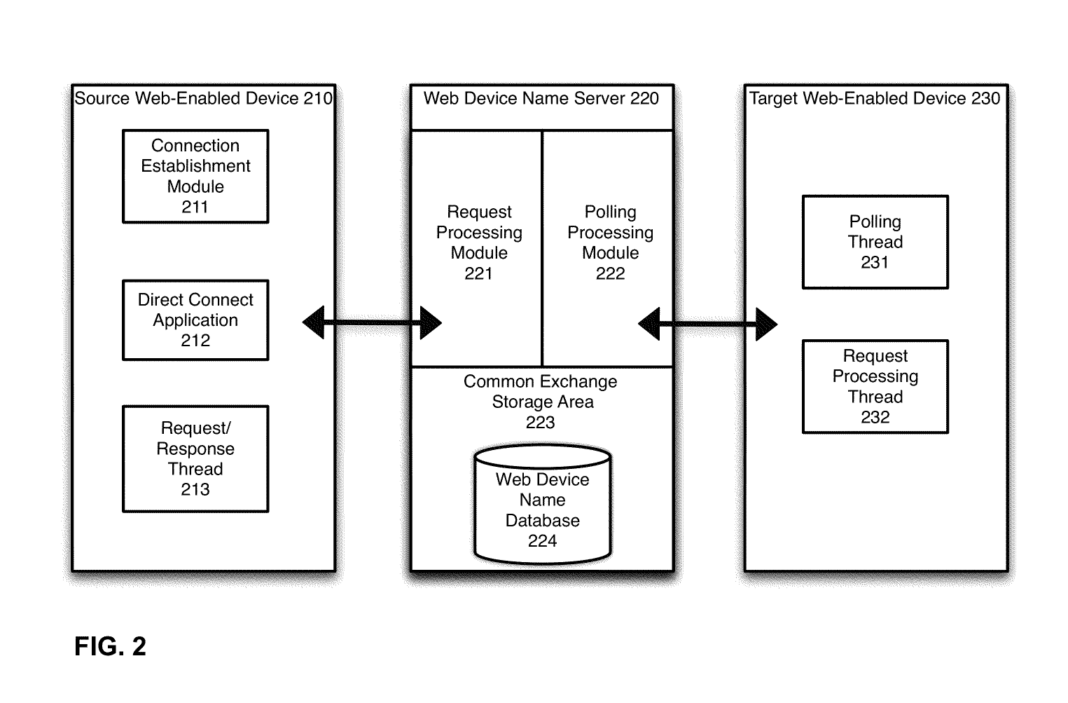

FIG. 2 is a block diagram conceptually illustrating various functional units of a source Web-enabled device 210, a Web device name server 220 and a target Web-enabled device 230 in accordance with one embodiment of the present invention. In the context of the present example, Web device name server 220 acts as an intermediary to receive, buffer and relay communications between source Web-enabled device 210 and target Web-enabled device 230.

Source Web-enabled device 210 may represent any device that provides access to the Internet, including, but not limited to, a smartphone, a pocket Personal Computer (PC), an ultra mobile PC (UMPC), a tablet computer, a BlackBerry® wireless handheld device, an iPhone, an Android device, a Windows phone, a desktop/laptop computer, a web server or even a set top box. Similarly, target Web-enabled device 230 may represent any device that is capable of accessing the Internet, but typically, target Web enabled device 230 will be a mobile device.

In the present example, source Web-enabled device 210 includes a connection establishment module 211, a direct connection application 212 and a request/response thread 213. For sake of brevity and simplicity other standard Web-enabled device components are not shown.

Connection establishment module 211 may be used by source Web-enabled device 210 to identify another Web-enabled device (e.g., target Web-enabled device 230) to Web device name server 220 to which subsequent requests issued by source Web-enabled device 210 will be targeted. According to one embodiment, a unique identifier (e.g., the IMEI number or other unique identifier the user has approved to share) of the target device is used to identify the target device. In the simplified example provided below, in the context of an automated browser testing tool, connection establishment is via the Selenium “setTarget” method. In alternative implementations, each target request may contain a target device parameter specifying the target device to which the particular request is directed.

Direct connect application 212 may include a sequence of commands, requests, queries or the like to be carried out by target Web-enabled device 230 as well as logic for processing the results of same, if any. In the simplified Selenium example provided below, a single call is made to a “getTitle” method of an Android WebDriver to obtain the title of the current page being displayed by a web browser running on the target device.

Request/response thread 213 receives local requests issued by direct connect application 212, repackages them as necessary, forwards them to Web device name server 220 and waits for responses. When responses are received, they are reformatted as appropriate and sent back to the original requestor. In the simplified Selenium example provided below, this functionality is provided by a local listening server (e.g., listening server 740) implemented on source Web-enabled device 210.

In the present example, Web device name server 220 includes a request processing module 221, a polling processing module 222 and a common exchange storage area (CESA) 223, which may include a file system, a SQL database (e.g., Web device name database 224), TCP/IP connection, shared memory, shared streams, shared pipes and other standard Web server components.

Request processing module 221 is operable to process connection requests issued by connection establishment module 22 and to receive target requests issued by direct connect application 212 and transmitted by request/response thread 213. According to one embodiment, request processing module 221 accesses Web device name database 224 to validate connection requests and stores target requests within Web device name database 224. In one embodiment, CESA 223 or Web device name database 224 may implement a message queue for each available target device onto which target requests for that target device are placed.

Polling processing module 222 is operable to process polling requests received from target Web-enabled device 230. According to one embodiment, responsive to a polling request, polling processing module 222 registers the specific target Web-enabled device (e.g., target Web-enabled device 230) as an available device (if it isn't already registered) by storing the unique identifier of the specific target Web-enabled device within a table of available devices within Web device name database 224, for example. In some embodiments, a target Web-enabled device may be recognized as active for a predetermined or configurable amount of time from its last received polling request.

Depending upon the particular implementation and the content of the polling request, polling processing module 222 may store other information associated with target devices, including, but not limited to, information regarding who the user of the target device is (e.g., name, address, phone number, etc.), what the target device, operating system and/or terminal capabilities are (e.g., screen resolution, color capabilities, accepted compression, etc.), where the target device is (e.g., geo-location information, GPS, Zip/postal code, Bluetooth, Wi-Fi, area code, country, near field communications, radio frequency ID (RFID), cell tower triangulation any other method of determining location), when (e.g., time and/or date) the target device interacted with (e.g., was registered and/or last polled) Web device name server and state information associated with external or internal sensors or monitors, including, but not limited to gyro status, humidity, temperature, etc.

Responsive to a polling request, polling processing module 222 may also query Web device name database 224 to determine whether any pending requests exist for the specific target Web-enabled device (e.g., target Web-enabled device 230); and, if so, the request may be returned as part of the response to the polling request.

In the present example, target Web-enabled device 230 includes a polling thread 231 and a request processing thread 232. For sake of brevity and simplicity other standard Web-enabled device components are not shown.

Polling thread 231 is operable to send polling requests and responses to target requests to Web device name server 220. According to one embodiment, the polling requests contain the unique identifier (e.g., the IMEI number or other unique identifier the user has approved to share) of target Web-Enabled device 230. The polling requests may serve two purposes: (i) registration of the specific target device; and (ii) retrieval of pending requests for the specific target device. Responses to target requests may acknowledge receipt of, completion of and/or provide results from the specific target device carrying out the corresponding target requests.

Request processing thread 232 is operable to process target requests issued by a source Web-enabled device (e.g., source Web-enabled device 210) and retrieved from Web device name server 220 by polling thread 231. In one embodiment, request processing thread 232 leverages the power of command-line programs or application or operating system APIs by issuing scripting commands originated by source Web-enabled device 210 (or a Web server) to target Web-enabled device 230 via HTTP tunneling. In the simplified Selenium example provided below, request processing is performed by a Selenium server thread running on the remote (target) device that interacts with a browser running on the remote (target) device.

In one embodiment, the functionality of one or more of the above-referenced functional units may be merged or further subdivided. Moreover, the various functional units can be communicatively coupled using any suitable communication method (e.g., message passing, parameter passing, blocking calls, polling methods and/or signals through one or more communication paths, etc.). Additionally, the functional units can be physically or logically connected according to any suitable interconnection architecture (e.g., fully connected, hypercube, etc.).

According to embodiments of the invention, the functional units can be any suitable type of logic (e.g., digital logic, software code and the like) for executing the operations described herein. Any of the functional units used in conjunction with embodiments of the invention can include machine-readable media including instructions for performing operations described herein. Machine-readable media include any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, etc.

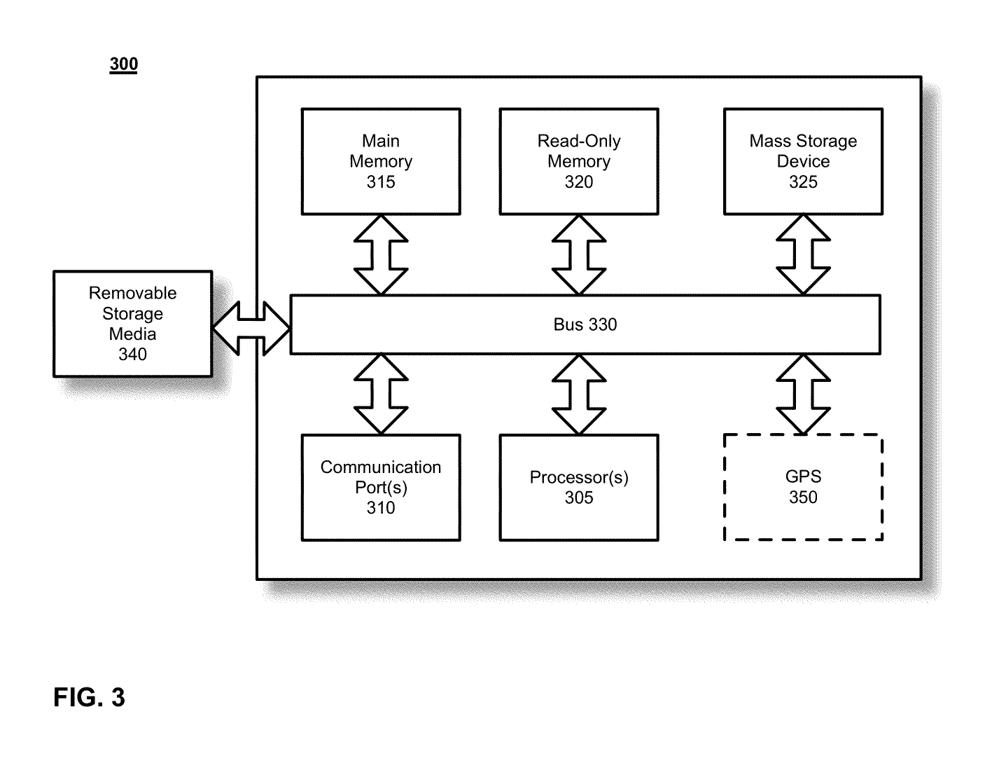

Embodiments of the present invention include various steps, which will be described in more detail below. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 3 is an example of a computer system 300, such as a source Web-enabled device (e.g., source Web-enabled device 210), a target Web-enabled device (e.g., target Web-enabled device 230) or a web server (e.g., Web device name server 220), with which embodiments of the present invention may be utilized.

According to the present example, the computer system includes a bus 330, at least one processor 305, at least one communication port 310, a main memory 315, a removable storage media 340 a read only memory 320, and a mass storage 325.

Processor(s) 305 can be any known processor, such as, but not limited to, mobile application processors or other processors designed for portable devices, such as the ARM Cortex™-A7, -A8 or A9 processor of ARM Holdings, one or more of Texas Instruments' OMAP family of processors (e.g., the OMAP2430 or the OMAPV2230), an Intel® 80386 processor, and Intel PXA901 processor, an Intel Itanium® or Itanium 2 processor(s), or AMD® Opteron® or Athlon MP® processor(s), or Motorola® lines of processors. Notably, future mobile devices are likely to have at least two processors, one for carrier processing and one for application processing.

Among other things, processor(s) 305 is generally responsible for executing various operational instructions maintained in main memory 515, and processing and otherwise interacting with various other input/output (I/O) devices, such as internal and/or external context data sources. In one embodiment of the present invention, processor(s) 305 may receive interrupts on a periodic basis from context data sources (e.g., external context source(s) 370, GPS receiver 360 and/or third-party context source(s) 350). Such interrupts may be received, for example, whenever new data is available from the particular source or on a periodic basis (e.g., every few seconds or so). Such interrupts may be received using any interrupt scheme known in the art including, but not limited to, using a polling scheme where processor(s) 305 periodically reviews an interrupt register, or using an asynchronous interrupt port of processor 305. Alternatively or additionally, the processor(s) 305 may proactively request data from context data sources on a periodic or as needed basis. Based on the disclosure provided herein, one of ordinary skill in the art will recognize a variety of interrupt and/or polling mechanisms that may be used in relation to different embodiments of the present invention.

Communication port(s) 310 represent physical and/or logical ports. For example communication port(s) may be any of an RS-232 port for use with a modem based dialup connection, a 10/100 Ethernet port, or a Gigabit port using copper or fiber. Communication port(s) 310 may be chosen depending on a network such a Local Area Network (LAN), Wide Area Network (WAN), or any network to which the computer system 300 connects.

Communication port(s) 310 may also be the name of the end of a logical connection (e.g., a Transmission Control Protocol (TCP) and/or User Datagram Protocol (UDP) port). For example communication ports may be one of the Well Know Ports, such as TCP port 80 (used for HTTP service), assigned by the Internet Assigned Numbers Authority (IANA) for specific uses.

Main memory 315 can be Random Access Memory (RAM), or any other dynamic storage device(s) commonly known in the art. Read only memory 320 can be any static storage device(s) such as Programmable Read Only Memory (PROM) chips for storing static information such as instructions for processor 305.

Mass storage 325 can be used to store information and instructions. For example, hard disks such as the Adaptec® family of SCSI drives, an optical disc, an array of disks such as RAID, such as the Adaptec family of RAID drives, or any other mass storage devices may be used.

Bus 330 communicatively couples processor(s) 305 with the other memory, storage and communication blocks. Bus 330 can be a PCI/PCI-X or SCSI based system bus depending on the storage devices used.

Optionally, in the case of a server and typically in the case of a fixed client device, such as a desktop computer, operator and administrative interfaces 335, such as a display, keyboard, and a cursor control device, may also be coupled to bus 330 to support direct operator interaction with computer system 300. Other operator and administrative interfaces can be provided through network connections connected through communication ports 310.

Removable storage media 340 can be any kind of external hard-drives, floppy drives, IOMEGA® Zip Drives, Compact Disc—Read Only Memory (CD-ROM), MultiMedia Cards (MMCs), secure digital (SD) cards, such as miniSD and microSD cards, Compact Disc—Re-Writable (CD-RW), Digital Video Disk—Read Only Memory (DVD-ROM).

The components described above are meant to exemplify some types of possibilities. In no way should the aforementioned examples limit the scope of the invention, as they are only exemplary.

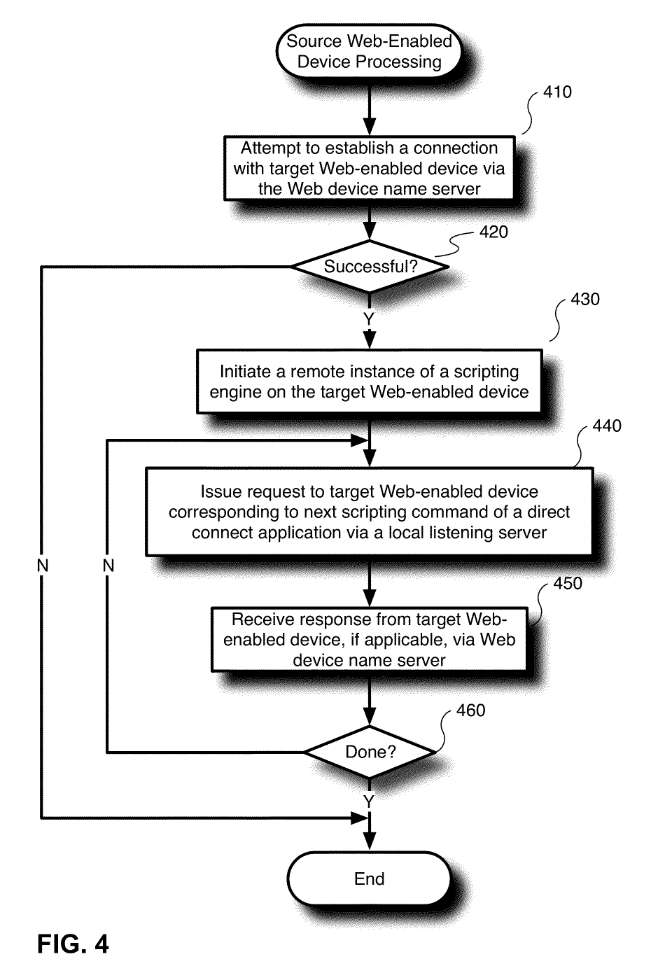

FIG. 4 is a flow diagram illustrating source Web-enabled device processing in accordance with an embodiment of the present invention. This processing may be triggered responsive to launching of an application or script on the source Web-enabled device, responsive to a command or directive issued directly or indirectly by an end user of the source Web-enabled device via a user interface of the source Web-enabled device, responsive to periodic automated processing performed by the source Web-enabled device or the like.

Before describing the present example, it is to be noted that two different approaches may be used to remotely control, monitor and/or otherwise interact with a remote target Web-enabled device. One is desktop focused and the other is Web focused. Older Selenium scripts (e.g., Selenium Remote Control style scripts), which were not designed for use in connection with mobile devices (due in part to the dynamic and changing nature of a mobile device's IP address dynamic), were typically run on a desktop computer system to perform automated web application user interface tests against websites that are accessed via a local proxy address over Wi-Fi, for example. When running a script (e.g., direct connect application 212) from a desktop computer, for example, in the context of embodiments of the present invention, it is desirable to implement a listening server (e.g., listening server 740) to repackage and transmit requests (that would in accordance with a standard usage model of Selenium be processed locally and issued to a browser running on the local machine) to a remote instance of Selenium server (e.g., Selenium server thread 940 running on a target Web-enabled device). Alternatively, when running the script from a server (the Web-focused approach), a listening server need not be implemented on the server. For completeness, the present example, is described in the context of a desktop-focused implementation.

At block 410, a source Web-enabled device attempts to establish a connection with a target Web-enabled device. According to one embodiment, this is accomplished by the source Web-enabled device sending a request that identifies the target Web-enabled device by its unique identifier to an intermediate server (e.g., a Web device name server), which maintains a list of available target Web-enabled devices. Notably, prior to attempting to establish the connection, the source Web-enabled device may have queried the Web device name server to obtain a list of available target Web-enabled devices, which may also be filtered accordingly (e.g., by geo-location, by type of device, by device capabilities, by installed software, by OS type/version, etc.). For example, the end user of the source Web-enabled device may be able to select an available target Web-enabled device via a drop-down list or other user interface mechanism.

At decision block 420, the source Web-enabled device determines whether the connection request was successful. For example, the Web device name server may provide a return code (e.g., “Success”) indicating the target Web-enabled device is on its list of available target Web-enabled devices or a return code (e.g., “Fail”) indicating the target Web-enabled device is not on the list of available target Web-enabled devices. If the connection request was successful, then processing continues to block 430; otherwise the source Web-enabled device processing is complete.

At block 430, the source Web-enabled device creates a remote instance of a script processing engine appropriate for the environment (e.g., mobile operating system and/or browser) of the specific target Web-enabled device to which a connection has now been successfully established via the Web device name server. In the simplified Selenium demonstration described below, a remote instance of an Android WebDriver is created on a target Web-enabled device as a result of a scripting command (i.e., “WebDriver driver—new AndroidDriver( );”) within JavaScript being executed by a source Web-enabled device.

According to one embodiment, this remote control functionality is facilitated by a local listening server implemented on the source Web-enabled device that listens on a predetermined address/port combination (e.g., 127.0.0.1:8080) associated with the script processing engine and processes local requests received on that address/port combination by repackaging the local requests and transmitting them to the target for processing. For example, as described further below, local requests may be transmitted via a tunneling protocol (e.g., via headers of HTTP requests) through one or more networks (e.g., the Internet and the carrier network) to the target. In this manner, the local listening server may transparently proxy local requests and causes them to be carried out by a remote scripting engine running on the target.

At block 440, a request is issued to the target Web-enabled device. According to one embodiment, the request is issued to the target Web-enabled device by first forming a local request representing a scripting command of a direct connect application (e.g., direct connect application 212) and sending it (as described above) via the local listening server. According to one embodiment, the local request is issued by sending it to a predetermined address/port combination (e.g., 127.0.0.1:8080) on which the polled request/response thread (e.g., listening server) is listening. The listening server may repackage the local requests as necessary for transmission to the target Web-enabled device via the point-to-point tunnel through Web device name server. According to one embodiment, the request comprises an HTTP packet that contains the scripting command or a representation thereof, thereby effectively tunneling the scripting command to a scripting engine running on the target. After transmitting the request, the request/response thread may wait for a corresponding response. Depending upon the particular implementation, the exchange of these and other requests and corresponding responses may be in accordance with an asynchronous or synchronous communication model.

At block 450, a response is received from the target Web enabled device via the Web device name server. According to one embodiment, when the response is received, it is reformatted as appropriate by the request/response thread and sent back to the original requestor.

At decision block 460, a determination is made regarding whether or not the source Web-enabled device is done sending requests to the target Web-enabled device. According to one embodiment, this determination is based on whether all scripting commands of a direct connect application (e.g., direct connect application 212) have been completed. If the determination is affirmative, then source Web-enabled device processing is complete; otherwise, processing loops back to block 440 to issue the next request to target Web-enabled device.

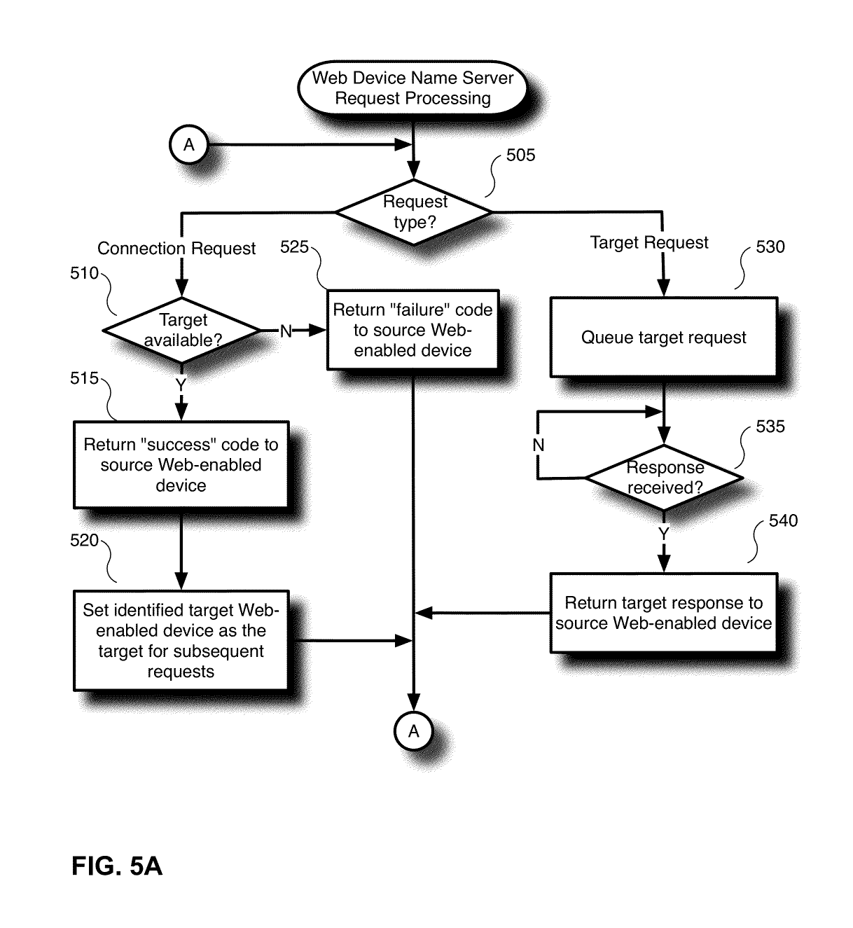

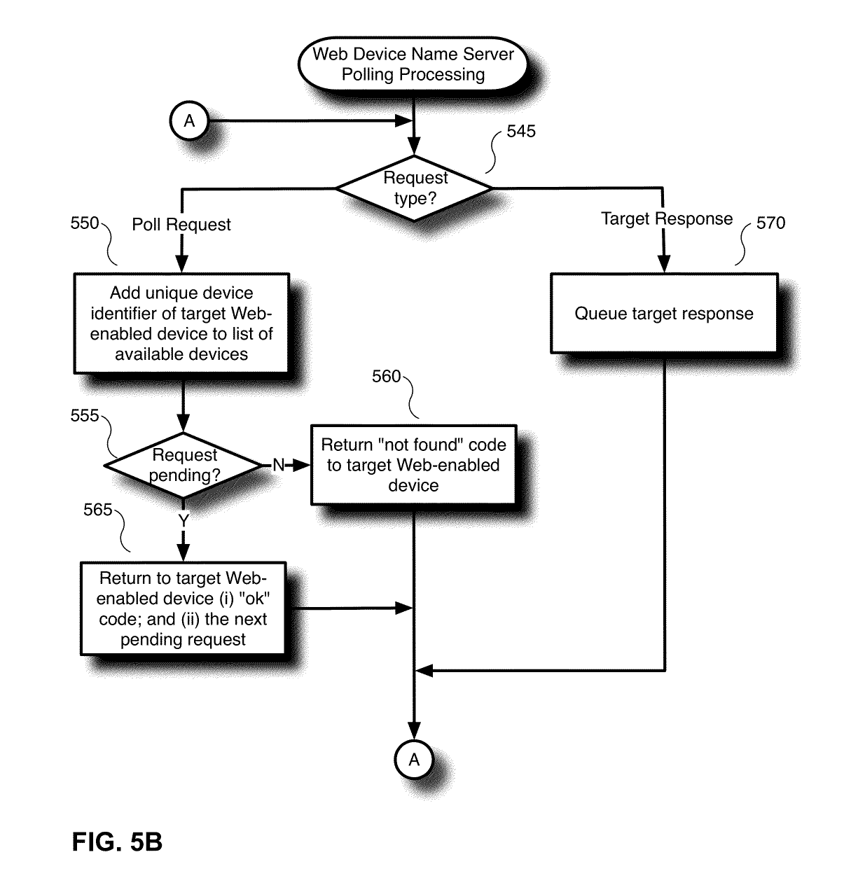

FIG. 5A is a flow diagram illustrating Web device name server request processing in accordance with an embodiment of the present invention. According to one embodiment, the Web device name server request processing is performed by a request processing thread (e.g., within request processing module 221) that is dedicated to handling requests received from source Web-enabled devices. Prior to decision block 505, it is assumed that a request has been received from a source Web-enabled device.

At decision block 505, the Web device name server determines the request type of a received request. According to one embodiment, there are two general types of requests that are issued by source Web-enabled devices—connection requests and target requests. A connection request generally represents a request by a source Web-enabled device to establish a connection to a target Web-enabled device via the Web device name server. A target request generally represents a command, request, query or the like issued by the source Web-enabled device and to be carried out by the specific target Web-enabled device. If the request type of the request at issue indicates the request is a connection request, then processing continues with decision block 510; otherwise, the request is a target request that is processed by blocks 530-540. Those skilled in the art will appreciate additional request types can be handled in a manner consistent with the discussion provided below.

At decision block 510, it has been determined that the request at issue is a connection request. As such, a determination is made regarding whether the specified target is available. According to one embodiment, the request processing thread accesses a common exchange storage area (e.g., common exchange storage area 223) to make this determination. For example, the request processing thread may query web device name database 224 to verify whether the specified target is currently registered with the Web device name server 220 as an available target Web-enabled device. If the target specified by the request is currently available, then processing continues with block 515; otherwise, processing branches to block 525.

At block 525, the specified target device is not an available target Web-enabled device. According to the present example, this precludes a connection from being established to the specified target device via the Web device name server and a return code (e.g., “failure”) is provided to the source Web-enabled device to indicate the Web device name server's inability to establish the requested connection. At this point, Web device name server request processing for the request at issue is complete and processing loops back to decision block 505 to process the next request received by a source Web-enabled device.

At block 515, the specified target device has been determined to be an available target Web-enabled device. According to the present example, this allows a connection to be established from the requesting source Web-enabled device to the specified target device via the Web device name server and a return code (e.g., “success”) is provided to the source Web-enabled device to confirm the requested connection has been successfully established and communication with the target device may commence.

At block 520, the Web device name server sets the specified target as the target for subsequent requests received from the source Web-enabled device. As noted above, alternatively, the source Web-enabled device may concurrently have connections established with multiple target Web-enabled devices. In any event, at this point, Web device name server request processing for the request at issue is complete and processing loops back to decision block 505 to process the next request received by a source Web-enabled device.

At decision block 530, it has been determined that the request at issue is a target request. According to the present example, such requests are queued for later retrieval by the specified target device. In one embodiment, the request processing thread executing on the Web device name server stores the request within a common exchange storage area (e.g., common exchange storage area 223) so it can be retrieved by the target device during its next polling cycle. For example, the request processing thread may issue a request to Web device name database 224 to store the target request on a request queue associated with the target Web-enabled device to which the target request is targeted.

After queuing the target request, the request processing thread waits for a response to the target request from the target device. At decision block 535, a determination is made regarding whether the response has been received. Depending upon the implementation of the common exchange storage area, the request processing thread may wait for the response to appear in the common exchange storage area using standard resource availability blocking calls or polling methods, whichever is appropriate under the circumstances. If the response has been received, the processing continues with block 540; otherwise, the request polling thread continues to wait for the response by looping back to decision block 535.

At block 540, the response to the target request has been received and it is returned to the source Web-enabled device. At this point, Web device name server request processing for the request at issue is complete and processing loops back to decision block 505 to process the next request received by a source Web-enabled device.

FIG. 5B is a flow diagram illustrating Web device name server polling processing in accordance with an embodiment of the present invention. According to one embodiment, the Web device name server polling processing is performed by a target request processing thread (e.g., within polling processing module 222) that is dedicated to handling requests received from target Web-enabled devices. Prior to decision block 545, it is assumed that a request has been received from a target Web-enabled device.

At decision block 545, the Web device name server determines the request type of a received request. According to one embodiment, there are two general types of requests that may be issued by target Web-enabled devices—poll requests and target responses (e.g., to target requests). A poll request generally represents a request by a target Web-enabled device to establish itself as an available target device and to retrieve any pending target requests for the target Web-enabled device. A target response generally represents a response to a target request issued by a source Web-enabled device that has been processed by the target Web-enabled device. If the request type of the request at issue indicates the request is a poll request, then processing continues with block 550; otherwise, the request is a target response and processing branches to block 570. Those skilled in the art will appreciate additional request types can be handled in a manner consistent with the discussion provided below.

At block 550, it has been determined that the request at issue is a poll request. As such, the unique identifier of the target Web-enabled device contained within the request is added to a list of available target devices maintained by the Web device name server. According to one embodiment, the target request processing thread accesses a common exchange storage area (e.g., common exchange storage area 223) to update the list of available target devices. For example, target request processing thread may issue a request to Web device name database 224 to add the specified target device to a table of available target devices.

At decision block 555, a determination is made if a target request is pending for this particular target device. According to one embodiment, the target request polling thread accesses a common exchange storage area (e.g., common exchange storage area 223) to make this determination. For example, target request processing thread may issue a query to Web device name database 224 to retrieve any pending target requests on a pending request queue corresponding to this particular target device. If a target request is pending for this particular target device, then processing continues with block 565; otherwise processing branches to block 560. In alternative embodiments, more than one pending target request may be returned to the particular target device at a time if multiple pending target requests exist.

At block 565, it has been determined that a target request is pending for the target Web-enabled device for which a poll request is being processed. As such, the pending target request is returned to the target Web-enabled device. According to one embodiment, responsive to the poll request, the target request polling thread returns a response with a return code (e.g., “ok”) indicating a target request exists for the target Web-enabled device and that target request is being returned with the response. At this point, Web device name server polling processing for the request at issue is complete and processing loops back to decision block 545 to process the next request received by a target Web-enabled device.

At block 560, it has been determined that no target requests are pending for the target Web-enabled device for which a poll request is being processed. According to the present example, responsive to the poll request, the target request polling thread returns a response with a return code (e.g., “not found”) indicating a target request does not exists for the target Web-enabled device and that no target request is being returned with the response. At this point, Web device name server polling processing for the request at issue is complete and processing loops back to decision block 545 to process the next request received by a target Web-enabled device.

At block 570, it has been determined that the request at issue is a target response. As such, the target response is queued to allow it to be returned to the source Web-enabled device that issued the corresponding target request. According to one embodiment, the target request processing thread accesses a common exchange storage area (e.g., common exchange storage area 223) to store the target response. For example, target request processing thread may issue a request to Web device name database 224 to add the specified target device to a response queue associated with the source Web-enabled device. At this point, Web device name server polling processing for the request at issue is complete and processing loops back to decision block 545 to process the next request received by a target Web-enabled device.

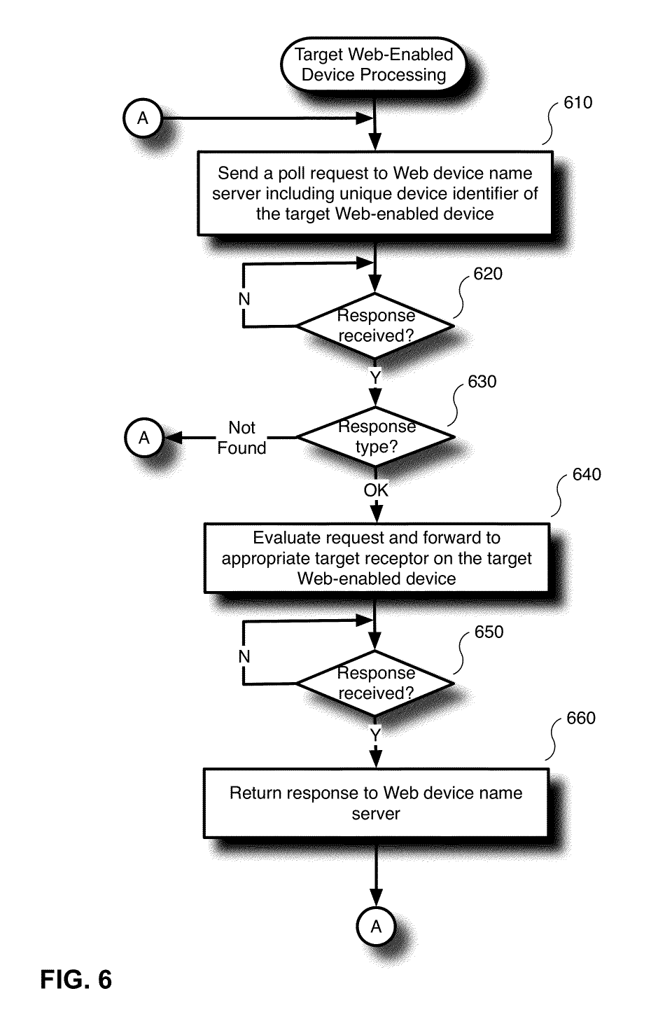

FIG. 6 is a flow diagram illustrating target Web-enabled device processing in accordance with an embodiment of the present invention. In the context of the present example, target Web-enabled devices periodically poll an intermediate server (e.g., Web device name server 220) to (i) register with the intermediate server as a target Web-enabled device that is available to receive target requests from a source Web-enabled device; and (ii) retrieve one or more pending target requests stored by the intermediate server and targeted for the target Web-enabled device. According to one embodiment, the target Web-enabled device processing is distributed between a polling thread (e.g., polling thread 231), which is dedicated to handling interactions with the Web device name server, and a request processing thread (e.g., request processing thread 232), which is dedicated to carrying out target requests received from source Web-enabled devices via the Web device name server.

Prior to block 610, it is assumed that a polling cycle has been triggered. The polling cycle may be triggered responsive to the expiration of a timer—creating a periodic polling cycle. Alternatively or additionally, the polling cycle may be event driven in which case an external or internal event (e.g., certain time of day, a sensor being triggered on the device, etc.) may initiate a new polling cycle. In one embodiment, so long as the polling results in the return of a pending target request, upon completion of the target request, the polling cycle may immediately be repeated; however, when the last polling request results in no pending target request being returned, the next polling cycle may be delayed for a predetermined or configurable amount of time. In this manner, target requests stored on the Web device name server will be processed as quickly as the target Web-enabled device is able to; however, the target Web-enabled device will not over burden the Web device name server with polling requests when no pending target requests exist. In one embodiment, target Web-enabled devices may poll the Web device name server every 5 to 30 seconds (e.g., 5, 10, 20, 30 seconds) to see if there is a pending target request or a response. This polling cycle may be predetermined or configurable.

At block 610, the target Web-enabled device sends a poll request to the Web device name server. According to one embodiment, the polling thread is configured to generate and transmit poll requests to the Web device name server in the background or when the target Web-enabled device is experiencing processing load below a predetermined or configurable threshold. Alternatively, the polling thread may be interrupt driven and may execute responsive to hardware, processor and/or software interrupts. In one embodiment, the poll request contains therein at least a unique identifier of the target Web-enabled device for use in connection with allowing the Web device name server to identify the target Web-enabled device as an active target device and for use in connection with source Web-enabled devices to direct target requests to the target Web-enabled device.

Depending upon the particular implementation and/or authorizations provided by the end user of the target Web-enabled device, the poll request may include other information associated with the target Web-enabled device, including, but not limited to, information regarding who the user of the target device is (e.g., name, address, phone number, etc.), what the target device, operating system and/or terminal capabilities are (e.g., screen resolution, color capabilities, accepted compression, etc.) and where the target device is (e.g., geo-location information, GPS, Zip/postal code, Bluetooth, Wi-Fi, area code, country, near field communications, radio frequency ID (RFID), cell tower triangulation any other method of determining location).

In the present example, after transmitting a poll request to the Web device name server, the target Web-enabled device waits for a corresponding response from the Web device name server. Again, depending upon the particular implementation, the poll request and response mechanism may be coupled and performed in a synchronous manner or decoupled and performed in an asynchronous manner as those skilled in the art will recognize.

At decision block 620, a determination is made regarding whether the response has been received from the Web device name server. Depending upon the particular implementation, the polling thread may wait for the response using standard blocking calls or polling methods, whichever is appropriate under the circumstances. If the response has been received, processing continues with decision block 630; otherwise, the polling thread continues to wait for the response by looping back to decision block 620.

At decision block 630, a determination is made regarding the type of response that has been returned by the Web device name server. If a return code (e.g., “not found”) within the response indicates no target requests were found for the target Web-enabled device, then target Web-enabled device processing for this poll request is complete and processing loops back to block 610 to perform the next polling cycle. If a return code (e.g., “Ok”) within the response indicates a target request for the target Web-enabled device is being returned within the response, then processing continues with block 640.

At block 640, the target request is evaluated and forwarded to an appropriate target receptor on the target Web-enabled device. In the simplified Selenium example provided below, the target request contains JavaScript invoking a call to a “getTitle” method of a Selenium server thread running on the target device. As such, the target receptor is determined to be the web browser running on the target device.

In the present example, after the target request is forwarded to the appropriate target receptor, the polling thread waits for a response from the target receptor. At decision block 650, a determination is made regarding whether the response has been received from the target receptor. As indicated earlier, depending upon the particular implementation, the polling thread may wait for such responses using standard blocking calls or polling methods, whichever is appropriate under the circumstances. If the response has been received, processing continues with block 660; otherwise, the polling thread continues to wait for the response by looping back to decision block 650.

At block 660 the response from the target receptor is return to the Web device name server. According to one embodiment, the polling thread repackages the response into a new request and transmits that request to the Web device name server where it is received by a target request processing thread within polling processing module 222, for example. At this point, target Web-enabled device processing for this poll request is complete and processing loops back to block 610 to perform the next polling cycle.

### EXAMPLES

As indicated above, as a result of ability to communicate with a target device without the source device requiring knowledge of the target's IP address or domain name, embodiments of the present invention enable numerous usage models, such as automated browser testing coupled with HTTP traffic performance testing, remote control of a target device, collecting sensor information from a remote device and the like. For purposes of illustrating the versatility of various embodiments of the contextual data communication platform, exemplary use cases and examples will now be described; however, these specific examples are in no way intended to be limit the present invention as various alternatives, modifications, and equivalents will be apparent to those skilled in the art without varying from the spirit of the invention.

### Example #1

### Automated Browser Testing

Selenium WebDriver (Selenium 2) is a relatively new tool for the development of automated tests for web sites and web applications easier. Selenium 2 represents the merger of the original Selenium project (Selenium 1) with the WebDriver project. Contributions to Selenium 2 from the WebDriver project include its object-oriented API for Document Object Model (DOM) interaction and browser control as well as its various browser driver implementations. Browser control in the context of the WebDriver approach differs greatly from that of Selenium 1. While Selenium 1 runs as a JavaScript application inside the targeted browser (thereby being limited by the JavaScript sandbox), WebDriver drives the browser directly by, for example, allowing access to native APIs from within the browser. For example, in the context of Internet Explorer, this means using C++ to drive IE's Automation APIs.

The merger of these two projects allows the strengths of one to mitigate the weaknesses of the other. For example, Selenium 1 has good support for most common use cases, but WebDriver opens up many additional possibilities via its ability to step outside of the JavaScript sandbox. Going forward, in the context of Selenium 2, both approaches will be available to developers to allow them to easily leverage the right tool for the particular job. While those skilled in the art will be familiar with Selenium and WebDriver functionality and features, others may wish to reference the following documents, which are hereby incorporated by reference in their entirety for all purposes:
Selenium Documentation, Release 1.0, which is currently available in PDF form at the following URL: http://oss.infoscience.co.jp/seleniumhq/docs/book/Selenium_Documentation.pdf.
“Get Started with Selenium 2,” by Sebastiano Armeli-Battana, which is currently available in PDF form at the following URL: http://www.ibm.com/developerworks/web/library/wa-selenium2/wa-selenium2-pdf.pdf.

In the following simplified demonstration, intended merely to illustrate the efficacy and potential of the present invention, a standard (off the shelf) automated browser testing tool (Selenium) is used to target a remote device based on its IMEI number to send a request to the device to determine the title of the browser page. Please note that any scripting or compiled language could be used along with any operating system on the remote device. This example uses what the assignee refers to as Scripting Interface Protocol—HTTP over Network (SIPHON). Therefore, while demonstrated with a particular scripting app (e.g., Selenium) and over a particular type of network (e.g., a carrier network coupled to the Internet), any scripting app may be used and any network that can carry HTTP may be used.

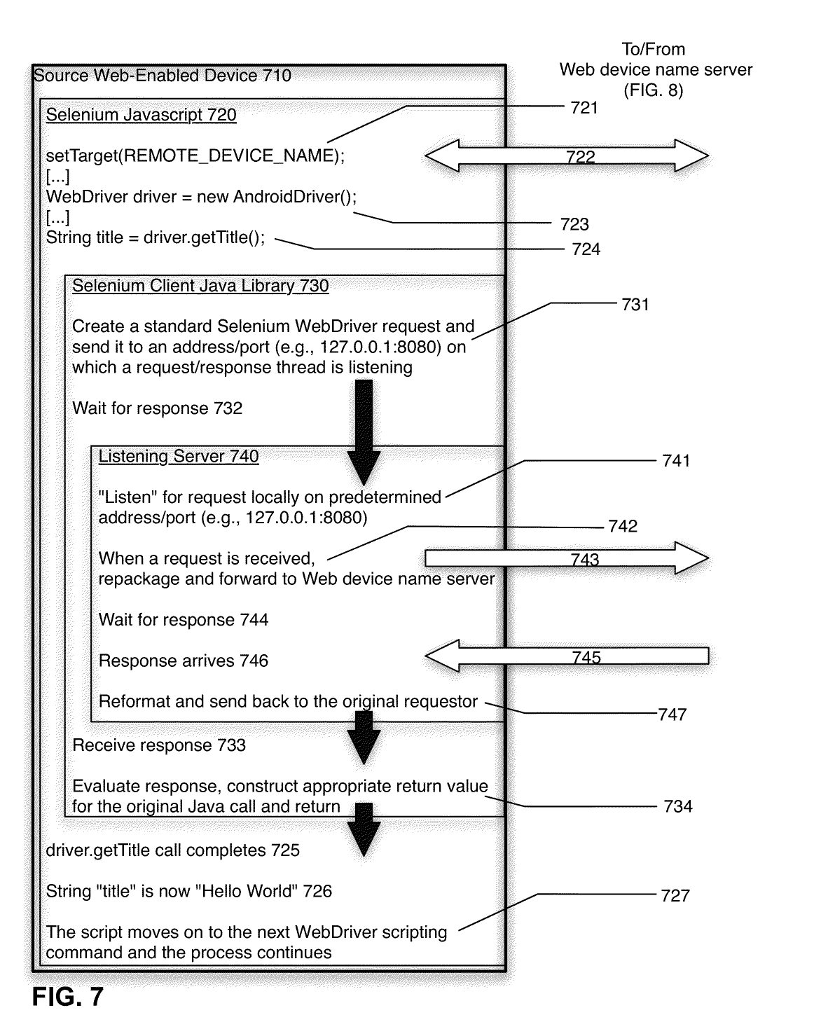

Components utilized for the particular demonstration illustrated by FIGS. 7-9 include a desktop PC (source Web-Enabled Device 710) running a software development kit, such as Eclipse, a Web server (Web device name server 810), and a remote mobile device (target Web-enabled device 910) running mobile operating system software (e.g., Android software, iOS software, etc.) and a browser.

In this demonstration, the Mobile Test Context is provided to Web device name server 810 by a poll request from target Web-enabled device 910 to Web device name server 810, which may employ HTTP X-Headers as described in commonly-owned U.S. Pat. No. 7,873,710, which is hereby incorporated in its entirety for all purposes. Notably, any current standard X-header or future X-header may be used as long as it contains information that uniquely identifies the target Web-enabled device.

FIG. 7 is a block diagram illustrating processing performed by source Web-enabled device 710 and interactions between source Web-enabled device 710 and Web device name server 810 in accordance with a simplified demonstration of an embodiment of the present invention. In the context of the present simplified demonstration, source Web-enabled device 710 is running a Selenium JavaScript 720 that is linked to Selenium client Java library 730. A listening server 740 serves as a source-side end point of the peer-to-peer HTTP tunnel through which the source and target exchange communications and handles repackaging and communication of target requests to Web device name server 810 and receipt and repackaging of target responses from Web device name server 810.

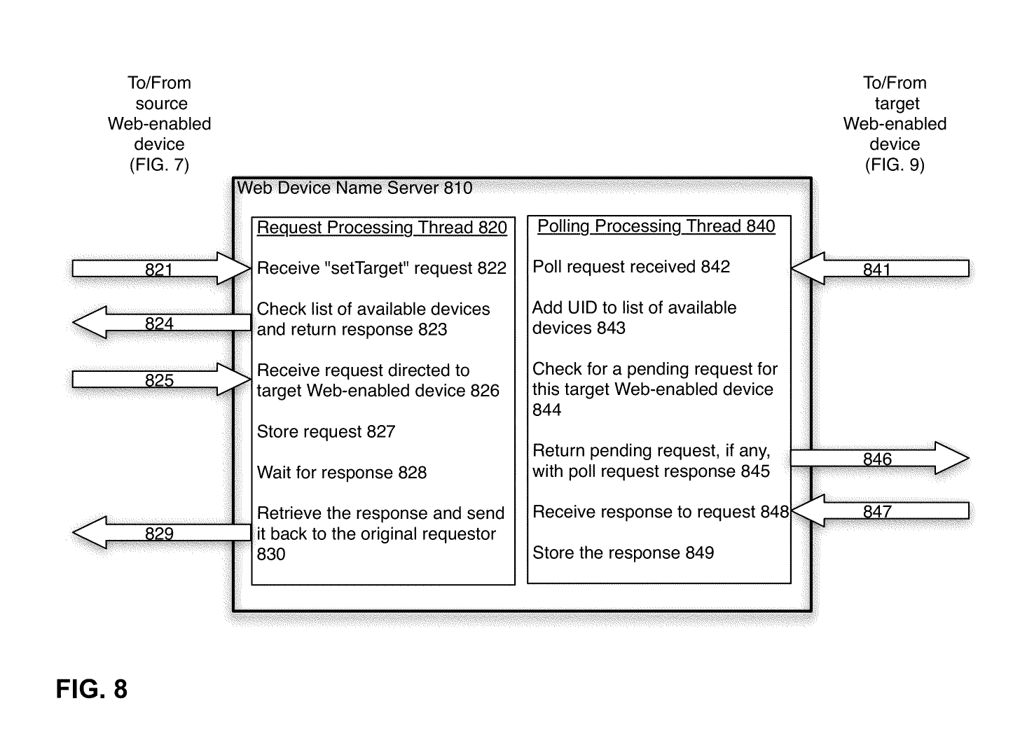

FIG. 8 is a block diagram illustrating processing performed by Web device name server 810 and interactions between Web device name server 810 and source Web-enabled device 710 and target Web-enabled device 910 in accordance with the simplified demonstration of an embodiment of the present invention. In the context of the present simplified demonstration, Web device name server 810 is shown executing a request processing thread 820 and a polling processing thread 840. Request processing thread 820 manages interactions with source Web-enabled devices, such as source Web-enabled device 710) and polling processing thread 840 manages interactions with target Web-enabled devices, such as target Web-enabled device 910.

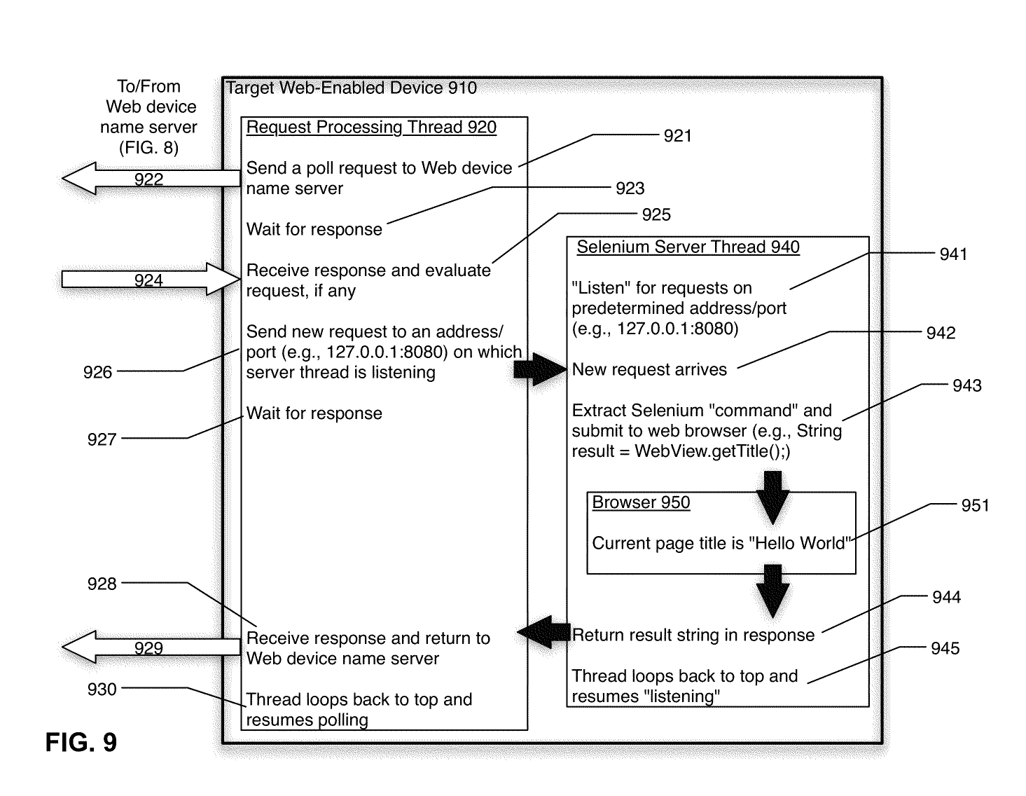

FIG. 9 is a block diagram illustrating processing performed by target Web-enabled device 910 and interactions between target Web-enabled device 910 and Web device name server 810 in accordance with the simplified demonstration of an embodiment of the present invention. In the context of the present simplified demonstration, target Web-enabled device 910 is shown running a request processing thread 920 (within an application or the operating system) and a Selenium server thread 940. Request processing thread 920 manages interactions with Web device name server 810 and may represent a target-side end point of the peer-to-peer HTTP tunnel through which the source and target exchange communications. Selenium server thread 940 processes target requests directed to a web browser (i.e., browser 950) that is running on target Web-enabled device.

With reference to FIGS. 7-9, the simplified demonstration will now be described. Beginning with FIG. 7, in the context of the present example, a JavaScript (e.g., Selenium JavaScript 720) was written and executed on source Web-enabled device 710 that requests the title of a Web page being displayed by browser 950 (a web browser running on target Web-enabled device 910).

At 721, a “setTarget” call is used to set up a peer-to-peer connection between source Web-enabled device 710 and target Web-Enabled device 910 via Web device name server 810. In this particular example, the IMEI number of target Web-Enabled device 910 is 12EA453267CEA. As such, the REMOTE DEVICE NAME parameter of the “setTarget” call is the string “IMEI.12EA453267CEA”. The HTTP request and response corresponding to this call is represented by double arrow 722.

Assuming Web device name server 810 returns a return code (e.g., “success”) indicating the connection request was successful, then the rest of Selenium JavaScript 720 may continue, including a call to initiate an instance of an Android WebDriver (723) (which ultimately creates a remote instance of the Android WebDriver on target Web-enabled device 910) and a call (e.g., String Title=driver.getTitle 724) to get the title of the Web page currently being displayed within browser 950.

Continuing with this simplified demonstration, Web device name server 810 receives the “setTarget” request 821 via HTTP and if the target device “name” (in this case, IMEI.12EA453267CEA) is included in a locally maintained list of available target devices, then a return code (e.g., “success”) indicating successful establishment of the requested peer-to-peer connection is returned to source Web-enabled device 710 and subsequent target requests issued by listening server 740 will be targeted for this target device. If the requested target device was not currently available or was not in the list, then a return code (e.g., “Fail”) indicating unsuccessful establishment of the peer-to-peer connection would have been returned.

Returning to FIG. 7, in the present example, at run time, Selenium Client Java Library 730 is linked to Selenium JavaScript 720. The “getTitle” call 724 creates a standard Selenium WebDriver request and sends it to an address/port (in this case, 127.0.0.1:8080) on which a listening server (i.e., listening server 740) is listening (741). When this “request” package is received by listening server 740, it is repackaged and forwarded as a special request to Web device name server 810 (742) in the form of an HTTP request 743. In this manner, locally issued standard Selenium WebDriver requests are actually repackaged and transmitted to Selenium server thread 940 where they are carried out. As noted above, while in this example, scripting commands are initiated via Eclipse (SDK) on a desktop computer system, it is to be appreciated that these scripting commands could instead be placed within a script to be executed directly by a server (e.g., within polling processing thread 840).

Returning to FIG. 8, request processing thread 810 receives the HTTP request (743/825) at 826 and reformats the request and stores the reformatted request 827 (e.g., writes it to Common Exchange Storage Area (CESA) 223). Request processing thread 810, then waits for a response to appear 828 in the CESA, for example, using standard resource availability blocking calls or polling methods, whichever is appropriate for the CESA scheme employed by Web device name server 810.

At the same time Web device name server 810 is receiving and processing requests from source Web-enabled device 710, it may be receiving poll requests from target Web-enabled device 910. For example, in FIG. 9, request processing thread 920 may send a poll request 922 to Web device name server at 921 in the form of an HTTP request. The poll request 922 includes a unique identification number (in this case, its IMEI number) of target Web-enabled device 910. After sending poll request 922, at 923, request processing thread 920 waits for a response from Web device name server 810. In one embodiment, geo-location information identifying the location of the target device can be included within one or more HTTP X-Headers and used by Web device name server 810 or source Web-enabled device 710 to create a real-time map, for example, showing the locations of all available/participating target devices (e.g., those that are registered as active target devices within Web device name database 224).

Returning again to FIG. 8, responsive to the poll request (922/841), polling processing thread 840 adds the IMEI number of target Web-enabled device 910 to a list of available devices at 843. Polling processing thread 840 also checks for a pending target request for target Web-enabled device 910 at 843. If there is a pending target request for this target device, then at 845 the pending target request is returned as part of a response 846 to this poll request 841.

Returning to FIG. 9, if response (846/924) includes a negative response code (e.g., “Not Found”), then there are no pending target requests for target Web-enabled device. If response (846/924) includes an affirmative response code (e.g., “Ok”), then there is a target request pending for target Web-enabled device 910 and is contained in the body of response (846/924). Assuming a pending target request is returned by response (846/924), it is evaluated 925 and forwarded to the appropriate target receptor on the target Web-enabled device 910. In the present example, at 926, the request is sent to a predetermined address/port (e.g., 127.0.0.1:8080) on which Selenium server thread 940 is listening 941 and waits for a response 927.

Responsive to receipt of the new request at 942, Selenium server thread 940 extracts the Selenium “command” (in this case, “getTitle”) and submits it to browser 950. In the current example, the current page title of the web page being displayed in browser 950 is “Hello World”. So, the result returned by the call “String result=WebView.getTitle( )” is “Hello World”, which is repackaged as a standard Selenium JavaScript Object Notation (JSON) response and returned to request processing thread 920 at 944. At this point 945, Selenium server thread 940 loops back to the top and resumes “listening.”

The response is received at 928 by request processing thread 920 and returned to Web device name server 810 repackaged into a new request in the form of an HTTP packet (929/847). At this point 930, request processing thread 920 loops back to the top and resumes polling.

Returning again to FIG. 8, the response (847/929) is now received by polling processing thread 840 at 848. This is the polling device (i.e., target Web-enabled device 910) returning a response to the last target request it received via response (846/924) to poll request (841/922). At 849, the response is stored. For example, polling processing thread 840 may write the response to CESA 223.

Request processing thread 820 has been waiting for this response at 828, so it now retrieves the response and sends it back to the original requestor at 830 in the form of an HTTP packet 829/745.

Returning again to FIG. 7, the response (745/829) arrives at 746—it is then reformatted and sent back to the original requestor (i.e., Selenium client Java library 730) at 747. At 733, Selenium client Java library 730, receives the response to the request it made to listening server 740. At 734, Selenium client Java library 730 then constructs the correct return value for the original Java call and “returns.”

The “driver.getTitle” call completes at 725 and at 726 the string “title” is now “Hello World”. At this point 727, Selenium JavaScript 720 moves on to the next WebDriver scripting command, if any, and the process continues. If there are no more requests, then Selenium JavaScript 720 exits.

### Example #2

### Performance Testing

Similar to the example provided above, a carrier may run performance tests on multiple (e.g., hundreds or thousands, if desired and permitted by the end users) mobile devices to measure or collect one or more performance metrics and/or network parameters (e.g., round-trip time, packet loss rate, throughput, bandwidth, latency, sustained frame rate, encoding quality, etc.) in various geographic locations and/or with various Internet services. Web content providers (e.g., blogs, news websites, social networking websites), online market place web sites, ecommerce companies, Web search engine providers, Application Service Providers (ASPs), Managed Service Providers (MSPs), Voice over IP (VoIP) service providers (e.g., Vonage and Skype), Internet Service Providers (ISPs) and the like may also be interested in measuring or collecting such performance metrics and/or network parameters in the context of different browsers, different browser version, different operating systems, different operating system versions, different mobile devices and/or over different carrier networks.

Alternatives

As noted above, for purposes of simplicity, various embodiments of the present invention are described in the context of specific scripting environments, network environments and data exchanges; however, numerous alternatives are contemplated including, but not limited to the following:
Using a logical name associated with a target Web-enabled device to identify the target Web enabled device in place of its unique identifier (which may be mapped to the logical name by the Web device name server)
Executing the desired script to remotely control, monitor or otherwise interact with the target Web-enabled device on a server being polled by the target Web-enabled device
Pushing IP address updates to the Web device name server from target Web-enabled devices in real-time as the IP address of the target Web-enabled device is changed, thereby allowing the Web device name server to use the target Web-enabled device to use the IP address to communicate with the target Web-enabled device

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
executing, by a first device, a script including one or more native JavaScript commands; and
causing the one or more native JavaScript commands to be carried out within a Web browser running on a target Web-enabled device by transmitting the one or more native JavaScript commands to the target Web-enabled device via a Hypertext Transfer Protocol (HTTP) tunnel through a network to which both the first device and the target Web-enabled device are coupled, wherein the one or more native JavaScript commands are targeted for the Web browser by virtue of a unique identifier of the target Web-enabled device and without requiring knowledge, by the first device, of an Internet Protocol (IP) address of the target Web-enabled device.

2. The method of claim 1, wherein the first device comprises a source Web-enabled device and wherein said transmitting the one or more native JavaScript commands comprises for each native JavaScript command of the one or more native JavaScript commands:
generating an HTTP packet containing therein the native JavaScript command; and
transmitting the HTTP packet to a server on the network that is being polled by the target Web-enabled device.

3. The method of claim 1, wherein the first device comprises a server that is being polled by the target Web-enabled device and wherein said transmitting the one or more native JavaScript commands comprises for each native JavaScript command of the one or more native JavaScript commands:
receiving a polling request from the target Web-enabled device in a form of an HTTP request containing therein the unique identifier; and
responsive to the polling request, transmitting an HTTP response containing therein the native JavaScript command.

4. The method of claim 3, wherein the HTTP request comprises an HTTP connection request and wherein the unique identifier is carried within a header of the HTTP connection request.

5. The method of claim 4, wherein the target Web-enabled device comprises a mobile device and wherein the unique identifier comprises an International Mobile Equipment Identity (IMEI) number of the mobile device.

6. The method of claim 2, wherein the HTTP packet comprises an HTTP connection request and wherein the native JavaScript command is carried within a header of the HTTP connection request.

7. The method of claim 6, wherein the target Web-enabled device comprises a mobile device and wherein the unique identifier comprises an International Mobile Equipment Identity (IMEI) number of the mobile device.

8. A method comprising:
executing, by a first device, a program or a script including one or more calls to an application programming interface (API) of a Web browser running on a target Web-enabled device; and
causing one or more native Web browser commands to be carried out by the Web browser by transmitting the one or more API calls to the target Web-enabled device via a Hypertext Transfer Protocol (HTTP) tunnel through a network to which both the first device and the target Web-enabled device are coupled, wherein the one or more API calls are targeted for the Web browser by virtue of a unique identifier of the target Web-enabled device and without requiring knowledge, by the first device, of an Internet Protocol (IP) address of the target Web-enabled device.

9. The method of claim 8, wherein the first device comprises a source Web-enabled device and wherein said transmitting the one or more API calls comprises for each API call of the one or more API calls:
generating an HTTP packet containing therein the API call; and
transmitting the HTTP packet to a server on the network that is being polled by the target Web-enabled device.

10. The method of claim 8, wherein the first device comprises a server that is being polled by the target Web-enabled device and wherein said transmitting the one or more API calls comprises for each API call of the one or more API calls:
receiving a polling request from the target Web-enabled device in a form of an HTTP request containing therein the unique identifier; and
responsive to the polling request, transmitting an HTTP response containing therein the API call.

11. The method of claim 10, wherein the HTTP request comprises an HTTP connection request and wherein the unique identifier is carried within a header of the HTTP connection request.

12. The method of claim 11, wherein the target Web-enabled device comprises a mobile device and wherein the unique identifier comprises an International Mobile Equipment Identity (IMEI) number of the mobile device.

13. The method of claim 9, wherein the HTTP packet comprises an HTTP connection request and wherein the API call is carried within a header of the HTTP connection request.

14. The method of claim 13, wherein the target Web-enabled device comprises a mobile device and wherein the unique identifier comprises an International Mobile Equipment Identity (IMEI) number of the mobile device.

15. A method comprising:
executing, by a first device, a program or a script including one or more calls to an application programming interface (API) of an application or an operating system running on a target Web-enabled device; and
causing one or more operations to be carried out by the application or the operating system by transmitting the one or more API calls to the target Web-enabled device via a Hypertext Transfer Protocol (HTTP) tunnel through a network to which both the first device and the target Web-enabled device are coupled, wherein the one or more API calls are targeted for the application or the operating system by virtue of a unique identifier of the target Web-enabled device and without requiring knowledge, by the first device, of an Internet Protocol (IP) address of the target Web-enabled device.

16. The method of claim 15, wherein the first device comprises a source Web-enabled device and wherein said transmitting the one or more API calls comprises for each API call of the one or more API calls:
generating an HTTP packet containing therein the API call; and
transmitting the HTTP packet to a server on the network that is being polled by the target Web-enabled device.

17. The method of claim 15, wherein the first device comprises a server that is being polled by the target Web-enabled device and wherein said transmitting the one or more API calls comprises for each API call of the one or more API calls:
receiving a polling request from the target Web-enabled device in a form of an HTTP request containing therein the unique identifier; and
responsive to the polling request, transmitting an HTTP response containing therein the API call.

18. The method of claim 17, wherein the HTTP request comprises an HTTP connection request and wherein the unique identifier is carried within a header of the HTTP connection request.

19. The method of claim 18, wherein the target Web-enabled device comprises a mobile device and wherein the unique identifier comprises an International Mobile Equipment Identity (IMEI) number of the mobile device.

20. The method of claim 16, wherein the HTTP packet comprises an HTTP connection request and wherein the API call is carried within a header of the HTTP connection request.

21. The method of claim 20, wherein the target Web-enabled device comprises a mobile device and wherein the unique identifier comprises an International Mobile Equipment Identity (IMEI) number of the mobile device.

22. A method comprising:
causing, by a source Web-enabled device, a Hypertext Transport Protocol (HTTP) tunnel to be established through a network between the source Web-enabled device and a mobile target Web-enabled device located remote from the source Web-enabled device, by transmitting an HTTP request to a server via the network, the HTTP request containing therein a unique identifier of the mobile target Web-enabled device;
controlling, monitoring or interacting with the mobile target Web-enabled device, by the source Web-enabled device, causing one or more scripting commands to be carried out by a scripting engine executing on the mobile target Web-enabled device by causing the one or more scripting commands to be targeted to the mobile target Web-enabled device by virtue of the unique identifier and tunneling the one or more scripting commands through the network via the HTTP tunnel, wherein the source Web-enabled device need not have knowledge of an Internet Protocol (IP) address of the mobile target Web-enabled device.

23. A method comprising:
receiving, by a server coupled to a network, a first polling request from a target Web-enabled device that is coupled to the network, the first polling request including a unique identifier of the target Web-enabled device;
responsive to the first polling request, the server, storing information identifying the target Web-enabled device as an available target Web-enabled device;
receiving, by the server, a target request from a source Web-enabled device that is coupled to the network, the target request intended for delivery to the target Web-enabled device and directed to the unique identifier;
storing, by the server, the target request within a database maintained by the server;
receiving, by the server, a second polling request from the target Web-enabled device, the second polling request including the unique identifier; and
responsive to the second polling request, the server, retrieving the target request from the database and returning the retrieved target request to the target Web-enabled device.
